(19) United States
(12) Patent Application Publication
(10) Pub. No.: US 2010/0174896 A1
(43) Pub. Date: Jul. 8, 2010

(54) METHOD AND SYSTEM TO UPDATE APPLICATIONS BASED ON AVAILABILITY SETTINGS

(75) Inventor: SHEKHAR GUPTA, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/349,267

(22) Filed: Jan. 6, 2009

(51) Int. Cl. G06F 9/00

(52) U.S. Cl. 713/100

(57) ABSTRACT

A method and system for updating one or more application settings based upon information contained in an availability setting. A determination may be made as to whether a first availability setting is activated for a first application associated with a user. In response to the determination that the availability setting is activated for the first application associated with a user, availability information included in the first application setting may be identified and a second availability setting for a second application associated with the user may be modified, in response to the identified availability information.

### BACKGROUND OF THE INVENTION

Modern businesses rely on computers and various software applications operating on them to perform an enormous range of tasks from keeping track of appointments to analyzing DNA code. Most offices use a software similar to Microsoft's® Office Outlook® for performing daily tasks such as calendar organization, e-mail, keeping track of contacts, and various other functions.

Additionally, most people have come to expect near constant access to people because of all of the technology available. Often times, going without a response to an e-mail for a period of time as short as an hour can lead to frustration or worse, the loss of a business opportunity.

### BRIEF SUMMARY OF THE INVENTION

In one or more embodiments of the present invention, by providing a method and system for monitoring an availability setting in which people alert others as to their whereabouts, other availability settings, may also be updated, including specific details included in an initially changed availability setting, based upon the initial determination that an availability setting has been changed.

In one embodiment of the present invention a method and system may be provided for updating one or more application settings based upon information contained in an availability setting. A determination may be made as to whether a first availability setting is activated for a first application associated with a user. In response to the determination that the availability setting is activated for the first application associated with a user, availability information included in the first application setting may be identified and a second availability setting for a second application associated with the user may be modified, in response to the identified availability information.

### BRIEF DESCRIPTION OF THE DRAWINGS

Illustrative embodiments of the present invention are described in detail below with reference to the attached drawing figures, which are incorporated by reference herein and wherein:

FIG. 1A is one embodiment of an environment for updating one or more applications based upon an availability setting;

FIG. 1B is another embodiment of an environment for updating one or more applications, including voice mail, based upon an availability setting;

FIG. 2 is a block diagram of one embodiment of components of a server configured to update one or more application settings based upon an availability setting;

FIG. 3 is a block diagram of modules in one embodiment, configured to update one or more application settings based upon an availability setting;

FIG. 4A is an illustration of one embodiment of a screen shot that may be displayed while selecting an availability setting;

FIG. 4B is an illustration of one embodiment of a screen shot that may be displayed while selecting an availability setting representative of being available;

FIG. 4C is an illustration of one embodiment of a screen shot that may be displayed while making calendar selections for availability;

FIG. 4D is an illustration of one embodiment of a screen shot that may be displayed for entering availability information;

FIG. 5A is a flowchart of one embodiment of a method for updating one or more applications based upon an availability setting; and

FIG. 5B is a flowchart of another embodiment of a method for updating one or more applications based upon an availability setting.

### DETAILED DESCRIPTION OF THE INVENTION

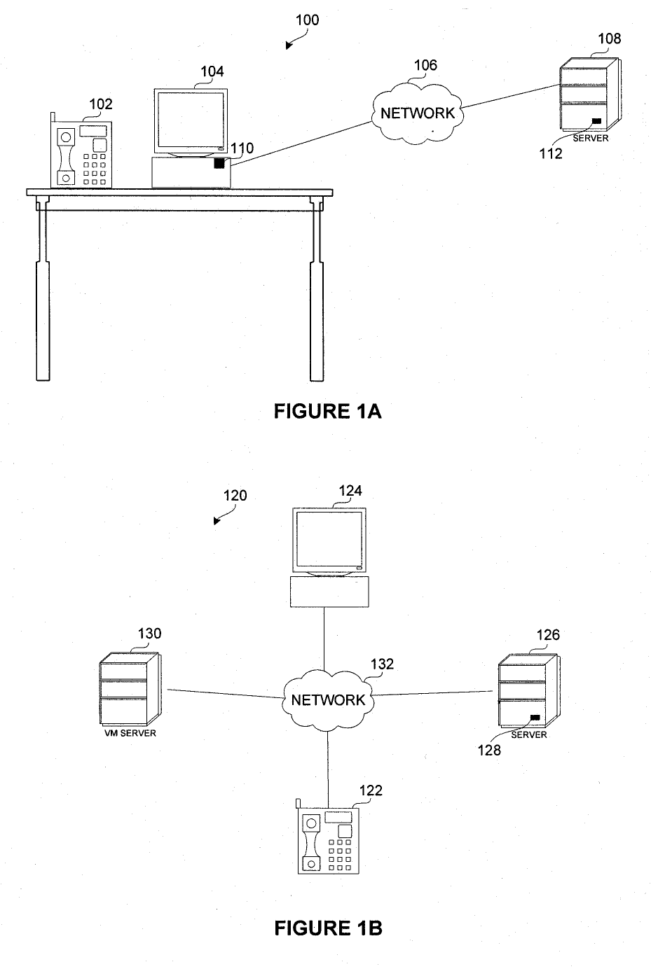

FIG. 1A is one embodiment of an environment 100 for updating one or more applications based upon an availability setting. In this embodiment, a telephone 102 may be in communication with a computing device 104 via a network 106, which may also be in communication with a server 108.

The telephone 102 may be any type of telephone, such as a telephone configured to operate over a public switched telephone network (PSTN), a voice over IP phone (VoIP) operating over an IP network, a cellular phone in communication with a network, or any other type of phone configured to communicate with the network 106.

The computing device 104 may be a desktop, laptop, smart phone, or any other computing device configured to operate on a network 106. Within the computing device 104 may be software modules 110 configured to carry out the availability setting functions that are described below for this invention. Alternatively, the server 108, which may be in communication with the network 106, may also or instead, contain software modules 112 with similar function to software modules 110 in the computing device 104.

The network 106 may be a PSTN, LAN, WAN, WiFi, or any other suitable network configured to communicate between the various devices, such as the telephone 102, computing device 104, and any other remote servers, such as server 108. The environment 100 may be similar to any traditional office setup, which may be either located all in one location or may be distributed with various portions of the environment 100 being located remotely.

FIG. 1B is an additional embodiment of an environment 120 for updating one or more applications, including voicemail, based upon an availability setting. In this embodiment, a telephone 122, a computing device 124, a server 126, including software modules 128, and a voicemail server 130 may all communicate via network 132. The environment 120 is similar to the environment described in FIG. 1A, with the exception of the voicemail server 130. The voicemail server 130 may be a separate server as depicted in FIG. 1B, may be a part of server 126, or may be a part of the computing device 124.

The voicemail server 130 may be configured to store incoming voicemail, outgoing greetings, as well as any other traditional functions of a voicemail server. By being in communication with the computing device 124 and the remote server 126, commands or other requests may be received by any of the connected devices allowing for the principles of the present invention to be applied to voice mail in addition to applications running on the telephone 122 or server 126. For example, utilizing environments 100 and 120, when an availability setting is modified for an application, such as initiating an out-of-office response message, calendar settings, also running on the server 112, may be modified in response. Other example embodiments are described below in greater detail.

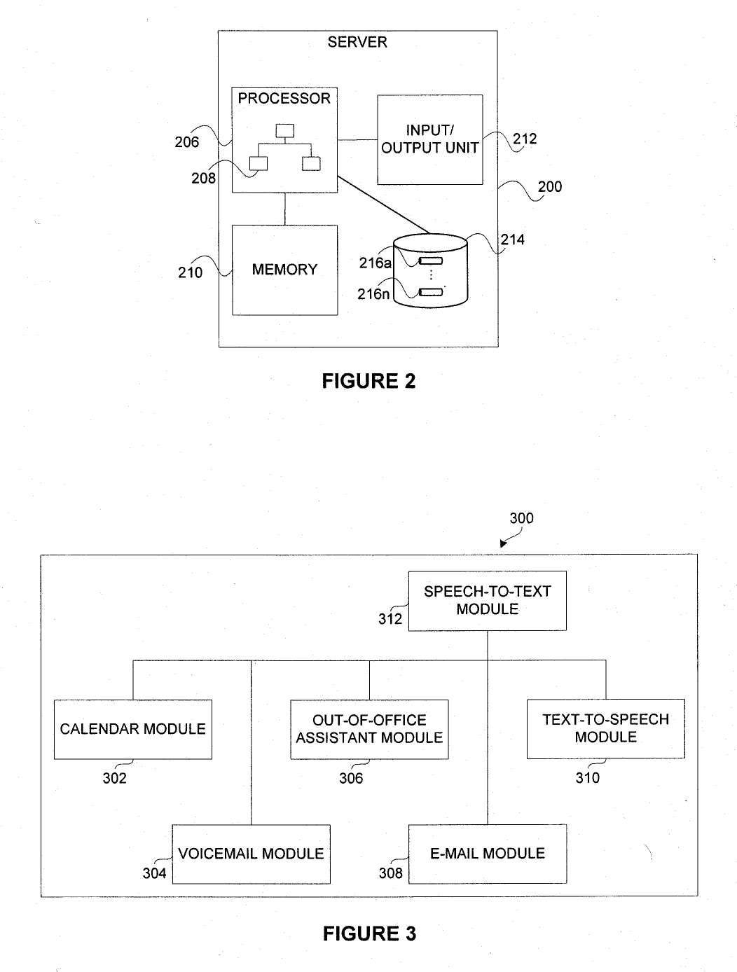

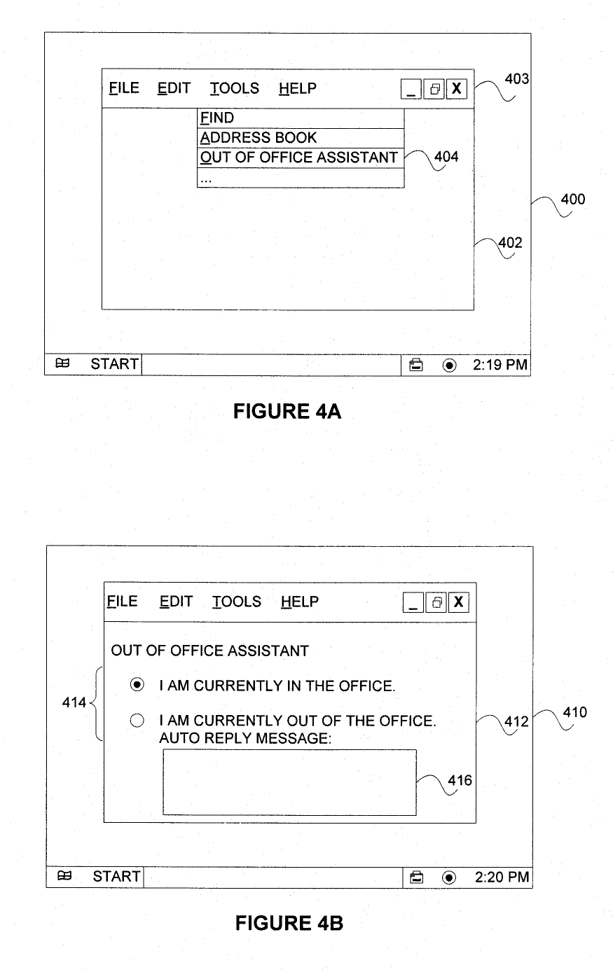

FIG. 2 is a block diagram of one embodiment of components 200 of a server configured to update one or more applications settings based upon an availability setting. The server 200 may include an input/output (I/O) unit 212 for receiving and communicating commands between various applications and devices. The server 200 may also include a processor 206 for processing the commands related to the availability settings. The processor 206 may execute software 208 capable of performing the functionality of the server 200. Software modules that operate in the software 208 are described below in more detail in reference to FIG. 3. Memory 210 may also be located within the server 200 for storing data being processed by the processor 206. A data storage unit 214 may also be included in or be in communication with the server 200. The data storage unit 214 may be a hard drive or any other type of volatile or non-volatile memory capable of storing data. Within the data storage unit 214 may be one or more data repositories 216a-216n, such as a database or multiple databases, capable of storing and organizing data. In one embodiment, rather than including the data storage unit 214, the server 200 may use a memory 210 that is large enough to store sufficient amounts of data.

FIG. 3 is a block diagram of modules 300 for one embodiment, configured to update one or more application settings based upon an availability setting. Various modules 300 may be used for carrying out the principles of the present invention, however in this embodiment the following are being described as examples of typical modules that may be used.

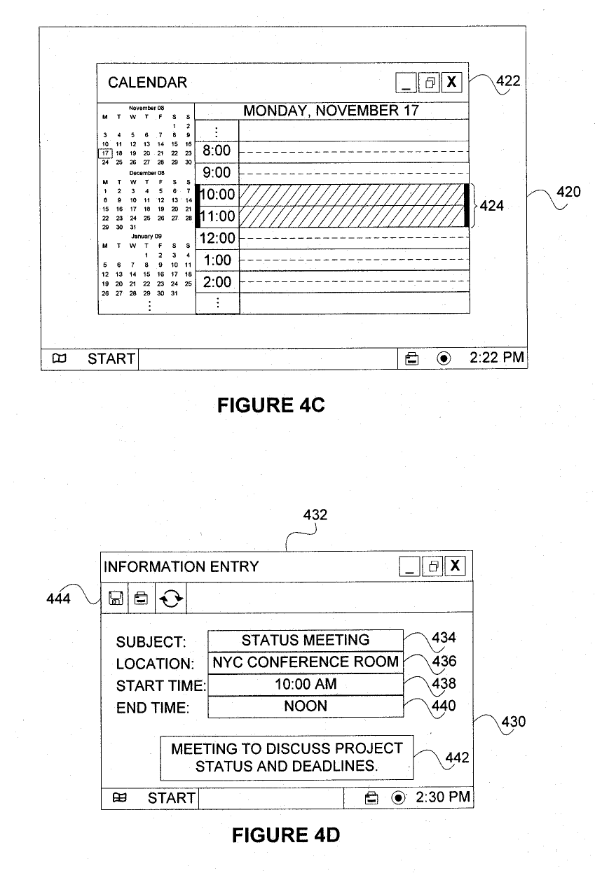

The calendar module 302 may be provided for keeping track of various appointments, dates, or any other information related to a petson's schedule. An example of a calendar module 302 is the Microsoft® Outlook® calendar. The calendar module 302 may allow for selections of blocks of time to be made with a description for the appointment occurring in the block of time to be entered. Traditional calendar modules operate independently of the other modules; however, according to the principles of the present invention, the calendar module 302 will interact with the various other modules as will be described below in reference to FIG. 4.

The voicemail module 304 operates to record, store, and play voicemail messages and greetings. The voicemail module 304 may be located, as described previously, within a telephone, a server, or within a separate voicemail server in communication via a network. Traditionally, if a user of the voicemail will be unavailable or out of the office, the user would manually initiate the voicemail feature and update their outgoing greeting to indicate that they are unavailable. Along with indicating that they are unavailable, they may provide additional details, such as when they may be returning or where they may be reached, in lieu of the number that was dialed.

An out-of-office assistant module 306 may also be used for providing notification that a user is not available. Traditionally, the out-of-office assistant, such as the out-of-office message used in Microsoft® Outook®, allows a user to enter a message that will be automatically sent to a sender of an e-mail explaining that the recipient is not available at the present time. For example, if someone was going on vacation for a week, they may use an out-of-office assistant module 306 to indicate the dates in which they are unavailable, as well as to enter a message which will be sent to any sender's of e-mails during that timeframe. A difference between a traditional out-of-office assistant and the out-of-office assistant module 306, as used in this invention, is that the out-of-office assistant module 306 may communicate with the other modules to share information without having a redundancy of operations to occur by the user.

The e-mail module 308 may work in conjunction with the out-of-office assistant module 306 to provide the e-mail response as set up by using the out-of-office assistant module 306. When a user has updated any application to indicate availability status, the e-mail module 308 may be automatically notified of the status change and adjust an e-mail response accordingly. For example, if the e-mail module 308 determines that the recipient is unavailable, the automatic response e-mail may be sent without any user interaction with the e-mail module 308. The e-mail module 308 may also function as a traditional e-mail module would function.

In one embodiment, the e-mail module 308 may additionally include functionality to provide an automatic response to calendar invites. Based upon out-of-office information from one or more of the modules, the e-mail module 308 may automatically accept or decline calendar invites for a particular user. Variations, such as only sending out automatic decline messages, rather than both decline and accept messages, or any number of possibilities are additionally contemplated by the invention. Another embodiment may include a rule or instructions to automatically decline any calendar invites within a set time period in which a user is determined to be out of the office. For example, a user may not wish to accept invites within 24 hours of being out of the office in order to allow for a day of uninterrupted work time. Once again, there may be many similar variations of rules that may be applied by the e-mail module 308. It is also important to note that while these modules as are being described predominately in an office environment, personal calendars and appointments may benefit from this invention as well.

A text-to-speech module 310 may be provided for converting written text, such as a description provided in a calendar entry using the calendar module 302, to create an automated voicemail message inclusive of the language within the calendar entry. In one embodiment, the text-to-speech module 310 may utilize text found within any of the one or more applications and determine the relevant information for use in a voicemail message. In one embodiment, the text may be broken into tokens by using predetermined fields, such as date, time, location, and many other fields. Alternatively, in a situation where text from an out-of-office reply message is used for the conversion into a voicemail message, other analysis may be provided in order to determine the useful information within the text. Various prompts or stored phrases may be accessed to parse together the relevant information obtained from the text into coherent sentences, suitable for a voicemail message. Without the user having to re-do their voicemail message, the text-to-speech module 310 may be configured to automatically provide a voicemail message based on the calendar entry information, or any other text information that the text-to-speech module has access to, which happens to be in text format.

In addition to the text-to-speech module 310, a speech-to-text module 312 may also be provided for converting speech from a voicemail message or other audio source into text, for use in updating various calendar entries, automatic e-mail replies, or other integrated applications. In one embodiment, the speech-to-text module 312 may be used to determine relevant information from within the audio data, such as a voicemail message, by breaking the message into tokens or phrases and indicating the relevant information. The relevant information, as well as any other useful information, may then be provided in text format to corresponding applications, which are configured to accept this type of information and create an intelligible entry.

Using a combination of the described modules, as well as other similar modules not specifically described, availability settings within other applications may not only be triggered, but also provided content for use in generating availability notification messages within the other applications. For example, in one embodiment, a voicemail greeting is changed to an out-of-office message. The voicemail greeting is as follows: “Thank you for calling ACME Co. I am currently on vacation in Alaska. I will be departing at 4:00 pm on Tuesday, May 21st and should be returning the morning of Friday, Jun. 2, 2009. I will not have access to email, but I can be reached by leaving a voicemail. I will check my voicemail in the evenings.”

In one embodiment there may be an application, such as a manager, that monitors various applications for changes in an availability setting. Using the manager, a flag may be checked, keywords may be monitored for, or any number of other methods to determine a change in availability may be used. In the above described voicemail greeting, the manager application may have determined that the message is indicative of an away message based on the text of the message. Alternatively, a user may set up a specific away message, which, by default, the manager will always recognize as an away message. Upon making the determination that the user is unavailable, a flag may be set to indicate that the user is unavailable. The flag may be sent or detected by other applications associated with the user using their own manager, or by use of a central manager in which applications associated with the user are in communication. In addition to a central manager, the invention contemplates that there may be other methods used in which applications that are additionally associated with the user may be determined.

Continuing with the voicemail greeting example, a correct translation algorithm may be determined based on the determined applications and in particular the application's type. For example, to convert the voicemail greeting to an out-of-office reminder, a simple speech-to-text application may be used. Newly translated text, based on the voice mail, may be communicated from the voicemail application to an out-of-office reminder application. The out-of-office message field may be automatically populated with the exact translation by the out-of-office reminder application. Alternatively, for an e-mail out-of-office reminder or a calendar application, the voicemail greeting may first be converted to text, then, tokens may be determined based on pre-stored information using the words included in the message and their location and context to each other and other phrases used in the voicemail. In the foregoing example, such tokens may include the name of the person assigned to the voicemail, the name of the company he works at, “departing”, “4:00”, “Tuesday”, “may”, “21st”, “2009”, “vacation”, “alaska”, “returning”, “June”, “2”, “2009”, “not”, “access”, “email”, “voicemail”, “will”, “check”, “voicemail”, and “evenings”. Such tokens can be associated based on their inclusion in a sentence together, the order in which they were presented, adjacent tokens, synonyms for such words, or known speech patterns of the person assigned to the voicemail. The dates and times may be used to select dates and times on a calendar starting (indicated by the proximity and order of time, day, and date tokens relative to the token “departing”) at 4:00 on Tuesday, Jun. 2, 2009 to create an appointment lasting until Friday, Jun. 2, 2009 (indicated by the proximity and order relative to the token, etc.).

Additionally, the appointment information itself may be filled out on the calendar with “On vacation in Alaska. Leave me a voicemail if you need to reach me. No emails. I will check voicemail in the evenings.” All of this information can be gleaned by an algorithm based on the results of parsing the text conversion of the voicemail, identifying tokens, and analyzing the relationships between the tokens and the rest of the message.

Another embodiment may convert information contained in a calendar module to update a voicemail greeting. Similar to the voicemail to out-of-office example, availability settings within other applications may not only be triggered, but may also be provided content for use in generating availability notification messages within the other applications by the calendar module. For example, the calendar entry may indicate that a user is unavailable from 2 pm until 5 pm on Wednesday December 31, by having the time blocked off. Within the fields, as will be described in FIG. 4 below, a message may indicate that the user will be at a doctor appointment.

In this embodiment there may also be a similar application or even the same application as described above, such as a manager, that monitors various applications for changes in an availability setting. Using the manager, a flag may be checked, keywords may be monitored for, or any number of other methods to determine a change in availability may be used. In the above described calendar entry, the manager application may have determined that the message is indicative of an away message based on the text of the message or because of a field being marked to clearly indicate that the user is out of the office. Upon making the determination that the user is unavailable, a flag may be set to indicate that the user is unavailable. The flag may be sent or detected by other applications associated with the user using their own manager, or by use of a central manager in which applications associated with the user are in communication. In addition to a central manager, the invention contemplates that there may be other methods used in which applications that are additionally associated with the user may be determined. In this case, the voicemail application is notified that the user is unavailable.

As before, a correct translation algorithm may be determined based on the determined applications and in particular the application's type. Rather that speech-to-text, a text-to-speech application may be used. Newly translated text, based on the calendar entry, may be communicated from the calendar entry application to an voicemail application. A new voicemail may be automatically generated with the exact translation of the text contained in the calendar entry by the out-of-office reminder application. Alternatively, tokens may be determined based on pre-stored information using the words included in the message, various fields, and their location and context to each other. In the foregoing example, such tokens may include the name of the person assigned to the calendar, the name of the company he works at, “doctor appointment”, “2 pm”, “Wednesday”, “December”, “31st”, “2008”, and “5 pm”. Such tokens can be associated based on their inclusion in a sentence together, the order in which they were presented, adjacent tokens, or synonyms for such words. The dates and times selected for the calendar entry may be used to include the information within the voice mail, without any additional user interaction.

The new voicemail greeting may be as follows: “Thank you for calling ACME Co. I am currently at a doctor's appointment. I will be departing at 2:00 pm and should be returning by 5:00 pm.” There are several other variations between different applications that are anticipated by the present invention, but should be enabled based upon the previous examples.

FIG. 4A is an illustration of one embodiment of a screen shot 400 that may be displayed while selecting an availability setting. A window 402 may be displayed depicting the various options that may be found in a program similar to Microsoft® Outlook®. One option that may be selected may be found under a heading option 403 labeled “tools”. After selecting tools 403, a submenu may display various options available. One option is the out-of-office assistant. The out-of-office assistant selection button 404 may bring up a separate window as is described in FIG. 4B below.

FIG. 4B is an illustration of one embodiment of a screen shot 410 that may be displayed while selecting a setting representative of being available. The window 412 may provide selections 414 allowing the user to select whether they are currently in the office or currently out of the office. If a user selects the second selection “currently out of the office”, an auto-reply message field 416 may be provided for allowing a user to insert a message for returning to a sender when the user receives an e-mail while marked unavailable. One advantage of the present invention is that the modules may be configured to use the information provided within the auto-reply message to populate other fields in the various applications in which the module is in communication with. As described previously, information from the various applications may be broken into tokens or fields (i.e., fields for leave date, return date, location, best contact method, etc.). Using the information deemed relevant to the current application as well as standardized phrases or connecting words, in this embodiment, the out-of-office reply message may be populated. One example of a standardized phrase including connecting words may be “The user <insert user name> is currently out of the office and will return <insert return date>.” There may be many other methods for determining relevant information, however, parsing into fields is given as simply one example.

FIG. 4C is an illustration of one embodiment of a screen shot 420 that may be displayed while making calendar selections indicating availability. In this embodiment, a calendar window 422 may be displayed. Within the calendar window 422 may be displayed various months in which a date may be selected. In this example, November 17 was selected. Within the chosen day, various hours are broken down and the time range between 10 AM and Noon has been selected. The user time selection 424 is highlighted in the illustration to indicate that an appointment has been made or the user is simply unavailable.

FIG. 4D is an illustration of one embodiment of a screen shot 430 that may be displayed for entering availability information. After selection of a timeframe, such as described FIG. 4C, the information window 432 may be displayed to a user for entering in detailed information for the time that was selected. Alternatively, the information window 432 may be displayed independently of a calendar selection. Some fields, such as a subject field 434, location field 436, the start time field 438, end time field 440, and a message field 442, may be automatically populated within the information window 432 by using similar methods as described previously. If a user was to manually enter in the information for an appointment, the subject field 434, location field 436, and message field 442 would likely need to be entered in manually. The start time and end time may be automatically populated based upon the selection made previously in FIG. 4C, however, these times may change and be entered in manually as well, or from a different associated application. One advantage of the present invention is the interoperability of the modules. Information already entered in other locations may be automatically populated within the fields of the information window 432. For example, had a voicemail message been altered previously, the voicemail manager module may operate to translate the message into text which may be used to populate the fields of the separate application, in this instance, the information window 432.

Likewise, if information entry is entered as described in FIG. 4D, an automatic e-mail reply, or any other application which is in communication with the present application may be modified, as well as a text-to-speech module may use the information contained in the fields to update a voicemail greeting.

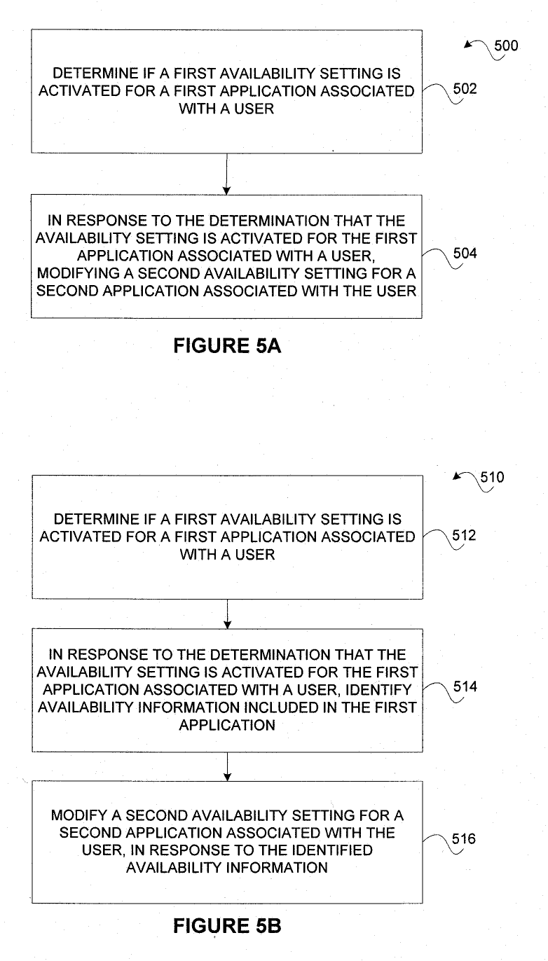

FIG. 5A is a flow chart of one embodiment of a method 500 for updating one or more applications based upon an availability setting. In step 502, a determination may be made as to whether a first availability setting is activated for a first application associated with a user. For example, in one embodiment, a user may set an away message for their e-mail to automatically reply to received e-mails. A manager or similar application monitoring the application settings may determine that an availability setting has been activated. The determination that the availability setting has been activated for an e-mail application may indicate a need for related applications, such as a calendar entry or voice mail, to modify their availability settings well. Accordingly, in step 504, in response to the determination that the availability setting is activated for the first application associated with a user, a second availability setting for a second application associated with the user may be modified. As described previously, upon the determination that an availability setting has changed in one application, one or more other availability settings in other applications may also be changed.

FIG. 5B is a flow chart of another embodiment of a method 510 for updating one or more applications based upon an availability setting. In step 512, a determination may be made as to whether a first availability setting is activated for a first application associated with a user. There may be multiple ways of determining if an availability setting has been activated. For example, a flag may be set that indicates the user is unavailable and a monitoring routine may monitor the flag. In one embodiment, for voicemail, a message may be analyzed for certain phrases or keywords that indicates that a user is unavailable. There are multiple indications of a change in availability setting, with these two provided simply for examples.

In step 514, in response to the determination that the availability setting is activated for the first application associated with a user, availability information included in the first application may be identified. Accordingly, the source of the availability information may be identified in order to facilitate the modification of the other applications availability settings. As discussed previously, one or more manager processes or applications may be responsible for maintaining availability information for the various applications. The identification of the availability may take place in may forms and may vary depending upon the format in which the information is presented. For example, if the first application is a voice mail message, a voice-to-text converter may need to be implemented in order to identify the availability information. Other applications may need the text-to-speech converter as described previously.

Various other methods may need to occur in order to identify the availability information included in the first application. A non-limiting listing of possible methods for the identification of availability information includes identifying keywords or phrases indicative of availability (i.e., departure date, departure time), various algorithm searches, as well as translation between various application formats.

In step 516, a second availability setting may be modified for a second application associated with the user, in response to the identified availability information. The information determined in step 514 may need to be routed to the other applications in order for the information to be utilized. A triggering mechanism within the individual applications or the manager, as described previously may need to indicate the new availability setting for each application being modified. Using various translations, key words, phrases, algorithms or many other methods, a new availability setting for each affected application may be composed.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed as new and desired to be protected by Letters Patent of the United States is:

1. A method for updating one or more application settings based upon information contained in an availability setting, said method comprising:
determining if a first availability setting is activated for a first application associated with a user;
in response to the determination that the availability setting is activated for the first application associated with a user:
identifying availability information included in the first application setting; and
modifying a second availability setting for a second application associated with the user, in response to the identified availability information.

2. The method according to claim 1, wherein modifying the second availability setting includes automatically modifying the second availability setting to include the identified availability information.

3. The method according to claim 1, wherein identifying availability information includes a keyword search of the first application setting.

4. The method according to claim 1, wherein identifying availability information includes performing a voice-to-text conversion of an audio message.

5. The method according to claim 1, wherein identifying availability information includes using times available from a calendar application.

6. The method according to claim 1, further comprising automatically declining meeting invitations in response to the second availability setting.

7. The method according to claim 1, wherein modifying a second availability setting includes marking calendar ranges as unavailable.

8. The method according to claim 1, wherein modifying a second availability setting includes adding additional language to the availability information to make a coherent sentence.

9. The method according to claim 1, wherein modifying a second availability setting includes ordering a message using the identified availability information.

10. The method according to claim 1, wherein availability information includes one of a departure time or departure date.

11. A system for updating one or more application settings based upon information contained in an availability setting, said system comprising:
a processor;
memory;
a storage unit;
said processor in communication with said memory and configured to:
determine if a first availability setting is activated for a first application associated with a user;
in response to the determination that the availability setting is activated for the first application associated with a user, said processor is further configured to:
identify availability information included in the first application setting; and
modify a second availability setting for a second application associated with the user, in response to the identified availability information.

12. The system according to claim 11, wherein, in modifying the second availability setting, the processor is configured to automatically modify the second availability setting to include the identified availability information.

13. The system according to claim 11, wherein, in identifying availability information, the processor is configured to include a keyword search of the first application setting.

14. The system according to claim 11, wherein, in identifying availability information, the processor is configured to perform a voice-to-text conversion of an audio message.

15. The system according to claim 11, wherein, in identifying availability information, the processor is configured to use times available from a calendar application.

16. The system according to claim 11, wherein the processor is further configured to automatically decline meeting invitations in response to the second availability setting.

17. The system according to claim 11, wherein, in modifying a second availability setting, the processor is configured to mark calendar ranges as unavailable.

18. The system according to claim 11, wherein, in modifying a second availability setting, the processor is configured to add additional language to the availability information to make a coherent sentence.

19. The system according to claim 11, wherein, in modifying a second availability setting, the processor is configured to order a message using the identified availability information.

20. The system according to claim 11, wherein identifying availability information includes identifying one of a departure time or departure date.
